(19) United States
(12) Patent Application Publication
(10) Pub. No.: US 2017/0028403 A1
(43) Pub. Date: Feb. 2, 2017

(54) MICROFLUIDICS MODULE AND CARTRIDGE FOR IMMUNOLOGICAL AND MOLECULAR DIAGNOSIS IN AN ANALYSIS MACHINE

(71) Applicant: AMODIA BIOSERVICE GMBH, Braunschweig (DE)

(72) Inventor: Ulrich KRAUSE, Braunschweig (DE)

(21) Appl. No.: 15/303,964

(22) PCT Filed: Apr. 16, 2015
(86) PCT No.: PCT/EP2015/058258

§ 371 Date: Oct. 13, 2016

(30) Foreign Application Priority Data
Apr. 16, 2014 (DE) 10 2014 105 437.7

(51) Int. Cl. B01L 7/00; F16K 99/00; B01L 3/00

(52) U.S. Cl. CPC B01L 7/52; B01L 3/502738; F16K 99/0013; F16K 99/0028; B01L 2200/0605; B01L 2200/10; B01L 2300/0816; B01L 2300/0867; B01L 2400/0487; B01L 2400/0622; B01L 2400/0644; B01L 2400/065; F16K 2099/0084

(57) ABSTRACT

The invention relates to a microfluidics module (100) for both the immunological and molecular diagnosis of samples, wherein channels (1, 3, 3′, 3″, 4, 7, 7′, 7″, 8, 8′) and/or cavities (2, 5) having inlets (1a, 1b, 3a-3i) for fluid samples and reagents, as well as inlet-assigned containers, container receiving means or container anchoring points are formed in a main body, and which module has a detection channel (80), for receiving a test-specific detection medium, that can be connected with channels (8, 7, 3) of the module. A central multi-port valve (6) is essential for the function, and controllably connects individual channels (3, 4, 7, 7′, 7″, 8) on the module. The channels belong to channel structures which are assigned certain functions and which are all directly or indirectly connected to the multi-port valve (6), wherein at least sections of the channel structures and channels form circuits (10, 30, 40, 70), the channels (1, 3, 3′, 3″, 4, 7, 7′, 7″, 8, 8′) and/or cavities (2, 5) of which circuits are at least partially arranged close to the base surface (120), in order to permit procedures, controlled by the analysis device, within the test process. The invention also relates to a cartridge (200) for receiving a microfluidics module (100), a reagent module (300), and a method for carrying out both immunological and, optionally, molecular tests using the microfluidics module (100).

The invention relates to a microfluidics module for both the immunological and the molecular diagnostics of samples in the form of a microfluidic chip, in which channels and/or cavities having inlets and outlets for fluid samples and reagents and also containers, container accommodators or container attachment points assigned thereto are configured in a base body, wherein the base body has, inter alia, a detection channel for accommodating an assay-specific identification dipstick. The invention further relates to an associated cassette for the accommodation of the microfluidics module, which cassette contains vessels or is preferably suited to accommodating vessels which communicate with the inlets and outlets of the microfluidics module, wherein the vessels are formed coherently in one piece or in multiple pieces and provide the volumes for reagents and samples. Furthermore, analysis units containing the microfluidics module according to the invention are provided. The invention further relates to a method for carrying out assays on samples with the aid of the new preferably cassette-held microfluidics module in an analyzer.

### PRIOR ART

In the field of diagnostics, there is a growing interest in simple, ready-to-use, self-contained, cost-effective disposable articles for carrying out molecular biology analyses and immunological analyses. The intention here is that use of these sensitive and specific methods is possible even without a specialized laboratory and specially trained personnel. In this connection, the trend is toward a miniaturization both of the instruments and of the structures accommodating the samples during the assay. Numerous analyzers have been developed which contain the biological samples in so-called cartridges or cassettes which can be disposed of after the assay. The analyzer is capable of optionally feeding samples and reagents—if they are not present in the cassette—and of transporting and processing them from the inlets or ports up to the identification area. Processing can, inter alia, consist in initiating mixing operations, heating and cooling runs, measurement value controls, aeration and venting steps, and lastly the readout of a measurement result.

DE 600 14 676 T2 (Cepheid) discloses, for example, a device and a method for analyzing liquid samples, it being possible to test analytes from lysed cells or viruses. WO 2005/028635 A2 discloses an automated system containing an extraction cassette in which a cell lysis is likewise carried out and on which microfluidic structures have already been realized, i.e., a miniaturization of the system is achieved. In the style of a terminological word originating from electronics, the term “microfluidic chip” or “microfluidics chip” emerged for planar cassette components which are usable in the aforementioned analyzers and contain miniaturized fluid line systems, cavities and the like. Numerous components for microfluidics chips have been developed by now. For example, EP 2 404 676 A1 discloses methods for making it possible to move fluids through a system of fluid channels in a specific manner, for example using pneumatic means and using valves and membranes.

DE 10 2008 002 674 B3 (IMM) describes a microvalve for controlling fluid streams in a microfluidics system, especially in a lab-on-a-chip system. With the aid of a valve body which is arranged in a movable manner relative to a substrate, for example the chip plate, and which has at least one channel, it is possible for fluid lines or fluid channels in the substrate to be either connected or separated. In comparison with already known valve models which could likewise block and release channels, an improved sealing effect is provided which can also be utilized for the sealing of a septum or of a venting membrane instead of the valve body. DE 10 2009 045 404 A1 (IMM) discloses the configuration of volume measurement channels or routes in microfluidics lines on microfluidic chips. This makes it possible to measure important exact sample volumes for chemical analysis.

With the aid of such means and similar means, numerous microfluidics chips have already been realized, including those for carrying out the polymerase chain reaction on DNA samples. Such as a PCR microfluidics chip is, for example, known from WO 2010/141139 A1. The chip is used within a cassette; both are disposed of after the assay.

The polymerase chain reaction (PCR) is by now the most important tool for molecular diagnostics via nucleic acid analysis. It makes it possible to copy only a few target molecules of a DNA again and again until there is a detectable number of molecules. For the detection of RNA, use is made of a reverse transcriptase (RT-PCR) in which the RNA is first transcribed into DNA by an enzyme. Before the nucleic acids can be amplified, they must first be extracted from a sample. This requires the measurement and addition of the sample and of the reagents, generally a lysis step to disrupt cell walls, and the subsequent purification and concentration of the nucleic acids. The subsequent analyses are frequently interfered with by inhibitors in the sample material; therefore, an optimized sample conditioning is essential for the quality of the analysis.

The standard PCR process requires incubating a sample alternately at three different temperatures. At the highest temperature, which is typically 95° C., the DNA is denatured, i.e., the two strands of the double helix separate into two single strands. At the subsequent annealing temperature, which must be adapted to the melting temperatures of the primers, said primers bind in a matching manner to the single DNA strands. At the following third temperature, which is typically 72° C., the polymerase extends the primers bound to the single strands using the matching DNA building blocks until there is a double strand again from the single strand. As a result, there is a doubling with each PCR cycle of the number of DNA molecules which were selected by the primers. The PCR process requires a temporal control of temperature change and also a precise temperature control.

In addition to PCR, there are further amplification methods for DNA, which, in some cases, may also proceed in an isothermic manner; these methods too require, however, an exact control of the conditions.

Different methods are used for the identification of DNA. The classic method is an electrophoretic separation with subsequent staining, which cannot be easily miniaturized. Other detection methods use fluorescent dyes. A relatively simple optical identification has been made possible with the aid of so-called lateral flow dipsticks (LFDs). Substances for identifying the analytes are located on the lateral flow dipstick. The analyte is transported along the dipstick with the aid of a liquid and is concentrated at the fixed detection molecules, and so it is possible to carry out an identification with the naked eye in the case of a color reaction, whereas a reader remains necessary in the case of a fluorescence identification.

The integration of extraction, amplification and identification on a microfluidic chip has a diversity of disadvantages. The solutions are generally specific for the type of samples, i.e., they are, for example, only suitable for highly concentrated DNA samples, such as blood cells or enrichment cultures. The reagents must in some cases be manually transferred to the chip or they are stored on the chip. The first variant requires an appropriately equipped laboratory environment and well trained personnel. This method is moreover prone to operational errors. The storage of reagents on the chip limits the quantities with which similar chips can be produced owing to the shelf life thereof. In addition, chips produced once can only be used for the originally planned assay. In some cases, expensive reagents are required. In some cases, complex read-out methods are used. Chip-based systems for molecular diagnostics are therefore still complicated in terms of handling, unflexible and expensive.

Additionally, a common wish is to be able to carry out immunological detections too with the same instrument. For this purpose, it is, however, necessary to carry out separate steps. Frequently, the analyte (antibody or antigen) is only present in a low concentration in the sample and must first be concentrated. This can, for example, take place with immobilized capture antibodies. Immunological assays which use an identification with LFDs are frequently supplied in plastic cassettes.

US 2008/0280285 A1 discloses microfluidic chips, associated methods and devices for immunological and/or molecular genetic assays which are to be carried out on a common chip. The chip is situated in a cassette which allows the feeding of liquid samples and reagents into a microfluidic structure via ports. The control of the analysis procedure with the aid of an analyzer is similarly described. Preferably, at least two treatment procedures are carried out on a microfluidic chip, for example a DNA isolation and a PCR amplification. In the case of various assays on a chip within a cassette, the fed sample is divided up and is conducted to discrete identification regions via parallel microfluidic structures. The results are read via a detector. It is envisaged that analytes from the group consisting of DNA, RNA, antibodies and antigens can be assayed on multiple parallel independent paths of the microfluidic structure. The methods are highly automated and specialized. For the various assay combinations, various individually designed chips are required, which chips must be handled on complex and specialized analysis apparatuses. This gives rise to disadvantages for relatively small laboratories, since all possible assays can only be offered under great expenditure.

It is therefore an object of the invention to avoid the disadvantages in the prior art and to develop universal means for carrying out various assays as desired, which assays encompass immunological and molecular diagnostic assays both at the nucleic acid level and at the amino acid level and can be carried out within an analyzer.

### DESCRIPTION OF THE INVENTION

According to the invention, this object is achieved by the features of the microfluidics module as claimed in claim 1, of the associated cassette as claimed in claim 9 and of the analysis unit as claimed in claim 11, of the reagent module as claimed in claim 14 and of the method as claimed in claim 15.

The invention thus offers a platform which, depending on the configuration, allows both immunological diagnostics and molecular diagnostics of analytes both at the nucleic acid level and at the amino acid level. The core of the invention is a universal microfluidics module on which various assay configurations of an immunological and molecular diagnostic nature can be realized. The universal microfluidics chip is provided with the detection means appropriate for the assay, preferably a lateral flow dipstick, prior to use, and the intakes or ports of the chip are, preferably within a cassette in the form of an analysis unit for example, equipped with containers for the sample containing the analyte and for one or more reagents. Alternatively, the containers can also be integrally joined to the microfluidics module, for example the containers can be formed above the channel intakes. The cassette or the analysis unit is inserted into the analyzer designed for the handling of the universal chip, and the work program appropriate for the particular assay is started. Owing to the skilful linking of standard treatment methods, the complexity of the analyzer itself is not substantially increased with respect to a pure PCR analyzer. Adaptation to the various assays is achieved by means of the program and the control of the chip-located central selection means in the form of the multiport valve. The architecture of the chip or microfluidics module according to the invention utilizes exactly one multiport valve. Said one multiport valve is the central switching point on the module. According to the invention, said one multiport valve allows the control of all processes which are carried out in the module according to the invention, from sample conditioning through sample processing, for example PCR or labeling of the analytes, through a possible purification up to identification and detection of the desired analyte in the sample. The channel structures “sample guidance/conditioning”, “reagent guidance”, “temperature-adjustment/amplification”, “volume measurement” and the detection channel are all directly or indirectly connected to the one central multiport valve and also controlled via said valve. This means that channels of the particular channel system lead to connectors of the valve (direct connection) or are connected to other channels which lead to connectors of the valve (indirect connection). In certain embodiments, parts of the “reagent guidance”, for example, are only connected to the central multiport valve via the “sample guidance”. The same universal chip design makes it possible to carry out a very wide variety of different assays on identically (universally) configured microfluidics chips. Samples and reagents are fed from the outside, and the chip can be manufactured in relatively large quantities, since it is usable in a diverse manner.

The expressions “inlets”, “intakes” and “ports” are used synonymously here.

The core of the invention additionally includes the fact that functional areas or segments, also referred to here as “zones”, are formed on the microfluidics chip, which zones represent standard segments of the assay methods, for example the segment for sample conditioning, a segment for sample treatment, a segment for the identification and detection of the analytes. These each comprise microfluidic channels or fluid lines, optionally cavities, optionally infeeds and outfeeds and also, in certain zones, means for moving the system-situated fluids composed of samples, reagents and mixtures thereof. Individual zones are arranged, or the associated channels or channel systems are grouped together spatially, such that specific program-controlled operations, for example temperature-adjustment, can be carried out in the zones.

Each functional area or zone is directly linked to the central multiport valve and, depending on the assay method and assay step, the multiport valve links individual selected zones to one another and, in so doing, brings about, for example, fluid measurement and fluid transport. The final transport is carried out to the detection channel, which is likewise accessible via the multiport valve and which contains the identification means, for example a lateral flow dipstick. The division of the microfluidics chip into functional zones or segments and the linking of said zones via the multiport valve as selection means makes it possible to form any conceivable assay comprising the steps of an immunological or of a molecular diagnostic analysis.

With the aid of the microfluidic system of the microfluidics chip, it is possible to realize at least the following method steps:
feeding the sample containing the analyte,
where necessary, feeding detection reagents,
mixing substances, for example sample and reagents, with the aid of mixing cavities or mixing routes,
transporting fluids, transferring sample volumes, for example by pneumatic transport,
separating the analyte by physical means,
measuring sample quantities/volumes,
adjusting the temperature of sample volumes in cavities or channel structures,
aerating and/or venting the fluid via membranes and valves,
reading the result, for example optically.

The microfluidics module according to this invention is a microfluidic chip on which the desired assay is performed within microfluidic structures. Said microfluidics module for immunological and molecular diagnostics on samples has the following essential components:
a preferably substantially plate-shaped base body and, in the base body, channels and/or cavities which form structures in the manner of a flow reactor. The microfluidic channels have cross-sectional areas of approx. up to one square micrometer, and so the entire assay is miniaturized and can be carried out within said microchannels and cavities. The typical volumes transported in the channels are within the region of microliters. However, it is also possible for substantially larger volumes to be transported from reservoirs to other reservoirs through the microchannels. The entire structure forms a “lab-on-a-chip”;
inlets for fluid samples and reagents and also containers, container accommodators or container attachment points assigned to the inlets. In this connection, the sample or samples and the possibly necessary reagents for the particular assay are held available in the containers and fed therefrom to the individual channels of the microfluidic structure via so-called ports, i.e., via inlets;
a detection channel for the accommodation of an assay-specific detection means, preferably a lateral flow dipstick which is connectable to further channels and especially various zones of the module, preferably to each of the zones as desired;
a multiport valve which connects or closes individual channels in a controllable manner, with each discrete valve setting corresponding to a channel pattern on the structure;
preferably a base surface configured on the base body for contact with an associated analyzer, with individual channels and/or cavities being configured such that at least parts or segments thereof are arranged close to the base surface in order to allow a manipulation or identification by elements of the analyzer within procedures controlled by the analyzer—the elements can, for example, be heaters, coolers, magnets, light barriers or spectroscopic or optical identification means; “close to the base surface” means in this connection that the channels and cavities are arranged such that the layer forming the base surface is of such a thin configuration that said manipulation or identification takes place through the layer while being minimally affected.
channel structures, specifically at least one channel structure for sample guidance including a conditioning necessary for certain assays, a channel structure for reagent feeding, a channel structure for a temperature adjustment and/or DNA amplification, and a channel structure for a defined volume measurement of a fluid moved through certain channel segments, which channel structures are all directly or indirectly connected to the multiport valve, with at least segments of the channel structures forming, according to their function or to their treatment according to the method, coherently arranged zones—in this connection, the channel structures may possibly overlap, i.e., certain channels can be shared for multiple functions;
a connection of the detection channel at least to volume measurement and to sample and reagent feeding via the multiport valve. In one embodiment, the microfluidics module according to the invention is one which substantially consists of a plastic. The module can be formed in one piece or in multiple pieces. In one embodiment, the channels and cavities are formed in plastic as open channels and cavities. These can be closed by a cover, for example after filling of individual cavities. In one embodiment, the cover is a film. In this case, the film forms, for example, the base surface which is in immediate contact with the analyzer.

The multiport valve of the microfluidics module is preferably configured as a rotary valve or as a slide valve. It is a microvalve having a valve seat and a valve body in which at least individual channels or channel structures of the ones described above open into the valve seat, with the valve body containing connecting channels by means of which certain channels on the module are then connected or unconnected. The multiport valve can, for example, allow two channels running adjacently to the valve to be connected. Rotating or sliding the valve controls whether and which adjacent channels are connected. The exact configuration of the connecting and separating options depends on the setup of the channel structure on the module. In practice, it is, for example, possible to use one multiport valve, as described in DE 10 2008 002 674 B3, which has already been acknowledged above. The content of DE 10 2008 002 674 B3 is therefore expressly incorporated in this disclosure by reference, since the guidance therein for designing the multiport valve can be readily utilized here by a person skilled in the art.

Preferably, the multiport valve has valve positions by means of which at least the following zones can be connected to their associated channels and channel structures:
the zone for sample guidance to the detection channel;
the zone for sample guidance to the zone for volume measurement;
the zone for sample guidance to the zone for temperature adjustment;
the zone for temperature adjustment to the zone for volume measurement;
the zone for volume measurement to the detection channel.

Another possibility is that each zone can be connected as desired to any other zone, with the detection channel being considered as a zone (detection zone). A further possibility is that subunits of zones can be connected to the multiport valve and, via said valve, to other zones. For example, the zone for volume measurement can be divided into subsegments; these can, for example, be utilized for the venting of channel segments.

According to the invention, there is exactly one multiport valve on the microfluidics module, which valve can, with its various settings, connect the stated zones including the detection channel to one another in various possible combinations. This does not rule out the presence of further simple valves or cocks on the module.

The selection of which channels are connected or separated in the particular analysis step is done in a program-controlled manner, usually via an external control unit by means of an associated analyzer.

The microfluidics module according to the invention is handled within an associated analyzer. Such instruments are absolutely known and do not need to be described here in detail. An analyzer for PCR assays which can handle a cassette equipped with a microfluidics chip is, for example, described in WO 2010/141139 A1. In the prior art, numerous further instruments which are matched to the different assaying purposes are known.

For the particular assays to be carried out as desired according to this invention, the associated analyzer has programs according to which the method steps are allowed to run. In this connection, a valve position is, inter alia, predefined for each step, which valve position is set with the aid of the analyzer and of the program running thereon. In a preferred embodiment, the analyzer therefore has an actuator and a control element, for example a pin which can act on the valve body and thereby move the multiport valve. Furthermore, the analyzer ensures the program-controlled transport of the sample or of the fluid or mixture situated in the channel structure using suitable means. Said means too are absolutely known. For example, EP 2 404 676 A1 shows means for the specific transport of fluid within microchannels. DE 10 2009 045 404 A1 shows both means for measuring fluid volumes in microchannels and the manner in which the measured fluids are transported. The disclosure content of DE 10 2009 045 404 A1 is therefore incorporated here by reference too. A person skilled in the art can readily adopt therefrom technical details for the configuration of gas-tight sealers and volume measurement routes.

According to a preferred embodiment of the invention, it is possible—preferably by appropriate arrangement and assignment of appropriate means in the analyzer in relation to the microfluidics module used—to connect means for transporting a fluid through channels of the module to suitable attachment points of the module, more particularly means for applying negative or positive pressure, means for feeding pressurized air into individual channels, and means for purging gases from individual channels in a liquid-tight manner. The latter can, for example, occur with the aid of the sealers shown in DE 10 2008 002 674 B3 and DE 10 2009 045 404 A1, which utilize liquid-impermeable and gas-permeable membranes in order to allow gas to escape in a specific manner.

The microfluidics module according to the invention can be inserted into a cassette or combined therewith, with the unit composed of the cassette with the microfluidics module then being inserted into a matching recess in the analyzer. The unit composed of cassette and microfluidics module is held and positioned in the recess in the analyzer, the latter especially with regard to the required manipulations by the instrument.

To achieve the object, the invention therefore also comprises a cassette for the accommodation of the microfluidics module, which cassette is configured according to the invention for a form-fitting and/or force-fitting insertion into a holder of an associated analyzer. It forms an interface between microfluidics module and analyzer in order to allow the performance of assays on the microfluidics module, which performance is program-controlled by means of the analyzer.

The handling of such cassettes is absolutely known in the prior art. The module according to the invention is either inserted into a cassette comprising individual containers for samples and reagents, which containers are assigned to the inlets on the module, or into a cassette containing a separate, coherent reagents module, as described in more detail below, or into an empty cassette if the containers are part of the microfluidics module itself and are assigned to the intakes (ports) and connected thereto.

According to a further aspect, the invention also provides a cassette or an analysis unit which comprises at least one microfluidics module equipped with an assay-specific detection means. The assay-specific detection means is preferably a detection dipstick and especially a lateral flow dipstick (LFD).

The cassette or the analysis unit is preferably equipped with one or more containers which are formed in one piece or in multiple pieces and arranged so as to be assigned to inlets of the microfluidics module and which provide volumes for reagents and samples. Such a cassette or analysis unit having containers can, for example, be formed in one piece as a unitary injection-molded part or in some other way. According to another advantageous design, separate individual containers or coherent multi-containers are connected in a form-fitting and/or force-fitting manner to the connectors of the microfluidics module to form a cassette or to form an analysis unit.

In a particularly preferred embodiment of the invention, the containers are formed within a coherent reagents module, the reagents module being connectable to the microfluidics module on the side facing away from the base surface of the microfluidics module in such a way that the containers containing the volumes for reagents and samples sit on the container attachment points of the microfluidics module in order to be able to feed the samples and reagents to the channels and to any cavities present via the inlets. The reagents module can be integrated into the cassette; it can also be formed in one piece with the cassette. Alternatively, both the microfluidics module and the reagents module can be inserted into a cassette preferably universally configured for all assays, which cassette then forms a frame. The containers sit above so-called “ports” of the microfluidics module. A “port” is understood here to mean any intake to a channel or channel system, for example in the form of a simple inlet (“penetration channel”) or of a sealable inlet (with input valve).

Furthermore, the analysis unit according to the invention can be formed from a microfluidics module according to the invention and from one or more containers, for example in the form of a reagents module. In this case, the containers or the reagents module can be integrated into the module or be present in a separate and connectable manner.

Lastly, the invention comprises a method for carrying out both immunological and molecular assays with the aid of the microfluidics module according to the invention within an analyzer, involving initially introducing a detection means in the microfluidics module and initially introducing at least one sample and possibly reagents in a cassette comprising the microfluidics module or in the microfluidics module itself and feeding them to the channel system of the microfluidics module in an instrument-controlled manner and involving conducting the sample and possibly the reagents in a controlled manner by means of the analyzer through microfluidic channels and lastly feeding them to the detection means after carrying out at least one of the instrument-controlled operations: transportation, washing, purification, selection of labeled molecules (for example, of magnetically labeled molecules comprising a magnet), mixing (for example, of a sample, by bubbling for example), mixing with reagents, allowing to react, adjustment of temperature, heating, cooling and measuring. For this purpose, an assay-specific program sequence which is installed on the analyzer and which is composed of steps is put together, which steps proceed in zones of the microfluidics module and which steps are selected via a multiport valve into which channels of the zones open and are linked in a sequence of method steps. The various possible assays (immunological or molecular) can be carried out as desired on the universally designed microfluidics module.

Preferably, the method is designed such that, after a sample which has or has not been mixed with reagents depending on the assay method selected and which has optionally been subjected to a purification, concentration and/or selection method has been fed through a microfluidic channel to the multiport valve, a selection controlled by the selected analysis program matching the assay method is made, according to which selection the multiport valve through connection of certain channels selects in the individual analysis steps from the following method steps and carries them out in an appropriate order:
measurement of a sample volume,
purification of a sample,
selection of labeled molecules, for example of magnetically labeled target molecules with the aid of a magnet,
washing, for example of a selected and fixed analyte,
concentration of target molecules/analytes,
amplification of DNA, preferably by means of PCR,
hybridization of DNA to probes,
transcription of RNA into DNA by means of reverse transcriptase,
   before the treated sample, likewise mediated via the multiport valve, is fed to the detection step within a detection channel.

The components reagents module and microfluidics module are preferably configured as disposable articles. The cassette too can be configured as a disposable article.

The detection means present in the detection channel is usually one which has a matrix, and a ligand of the analyte to be analyzed is bound in or on said matrix, said ligand binding the analyte specifically. In one embodiment, the detection means are known lateral flow dipsticks.

The invention will be more particularly elucidated below on the basis of exemplary embodiments which are illustrated with the aid of the figures, showing:

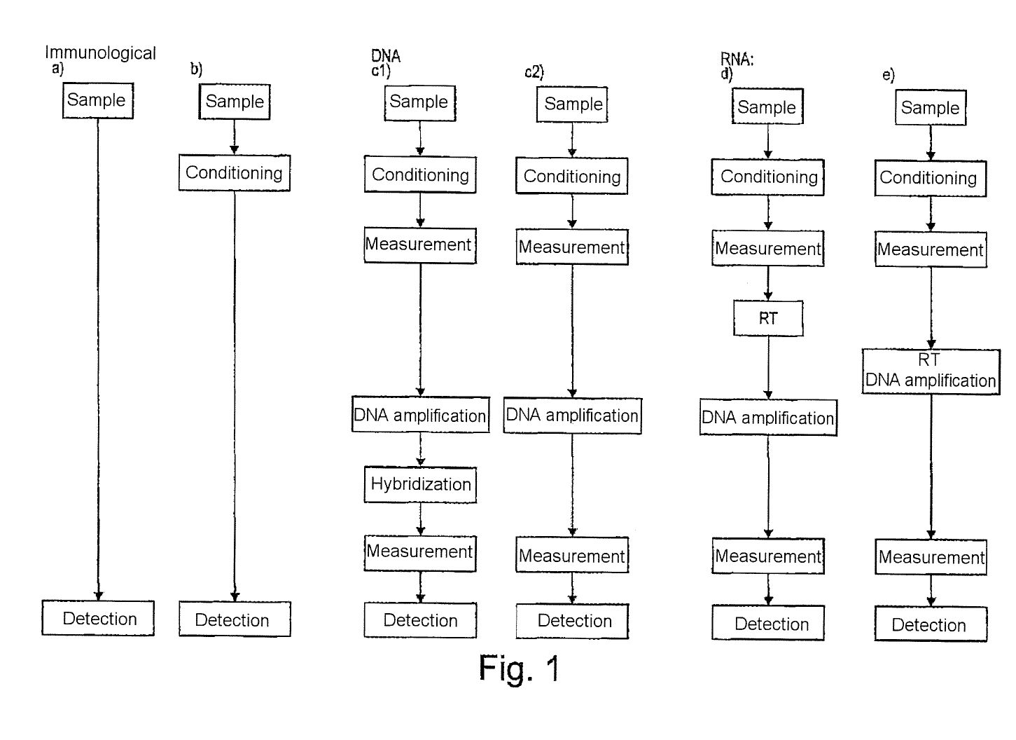

FIG. 1: a flow chart comprising the steps of various assay methods possible on the microfluidics module;

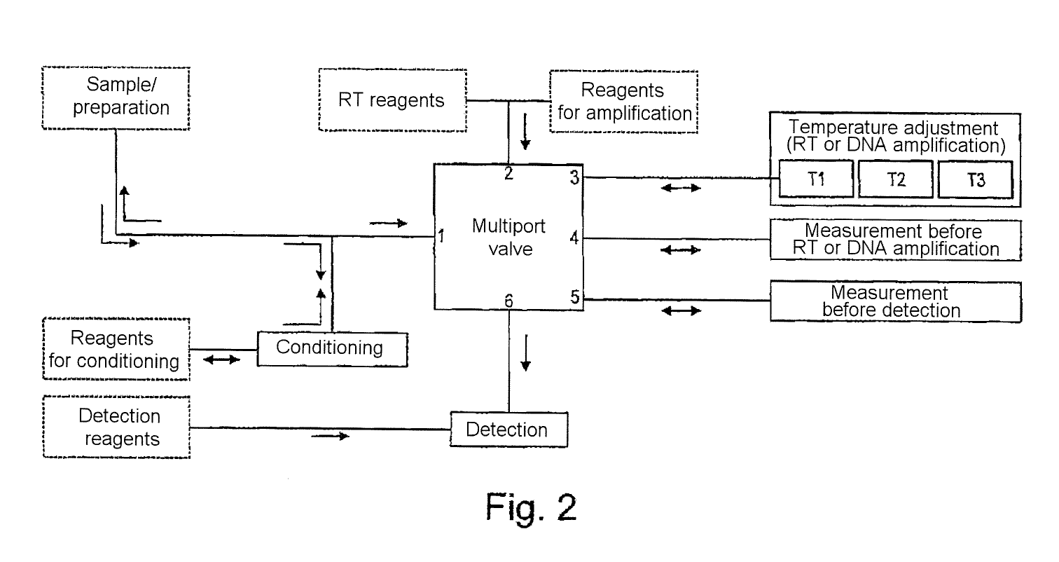

FIG. 2: sketch showing the principle behind dividing the microfluidics chip in order to realize the assay possibilities according to FIG. 1;

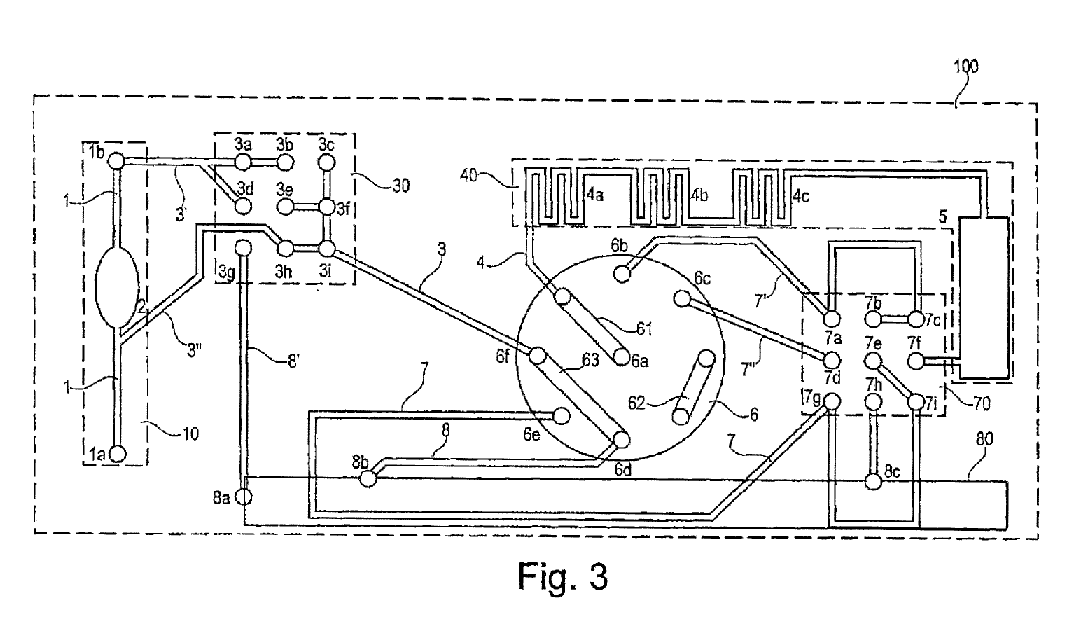

FIG. 3: schematic diagram of the microfluidics module with valve position for certain immunological assays;

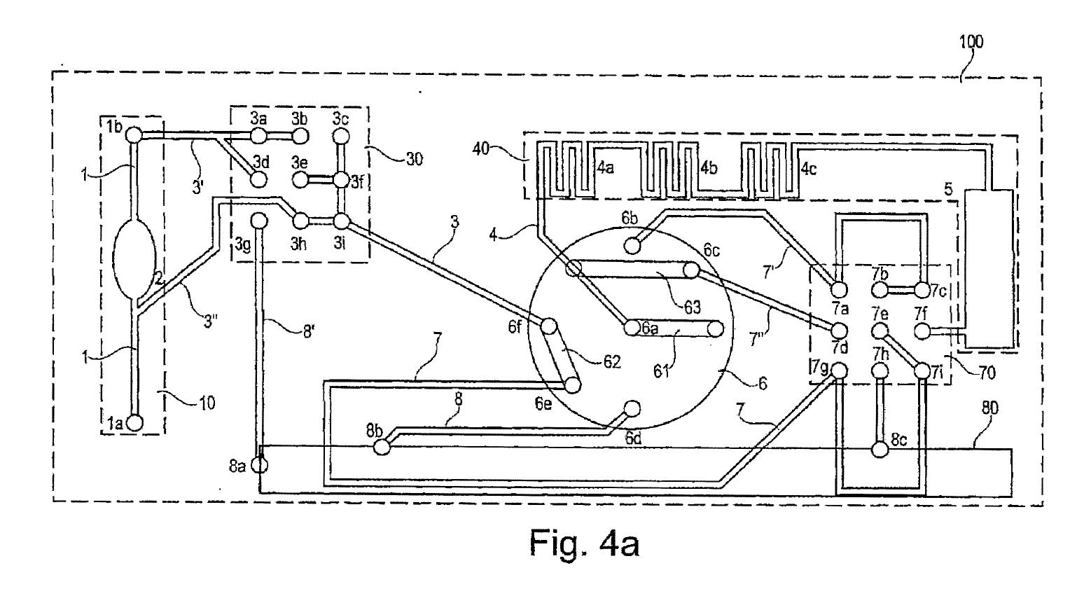

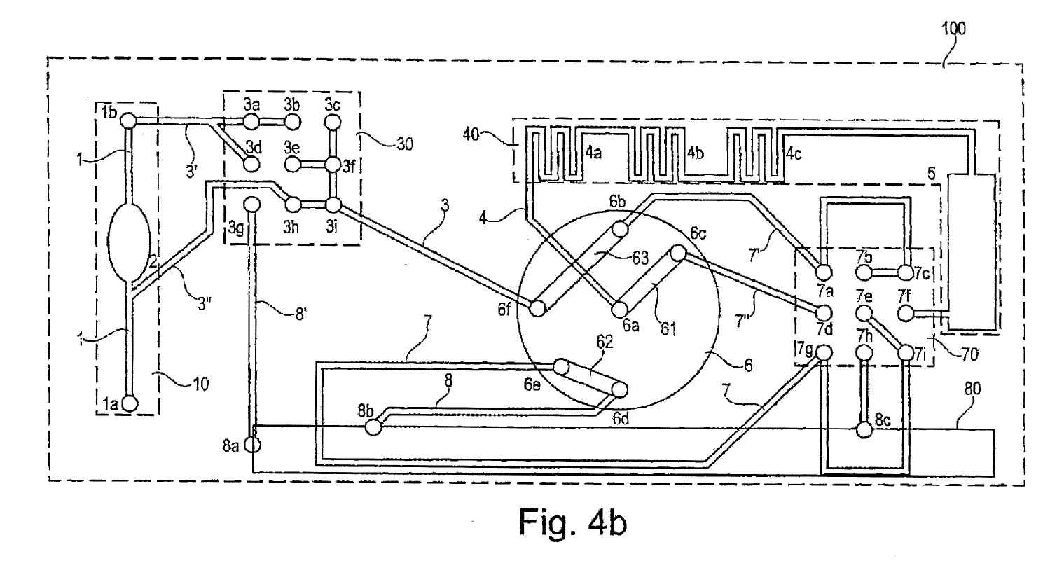

FIG. 4: schematic diagram of the microfluidics module from FIG. 3 with valve positions according to FIGS. 4a and 4b for further immunological assays;

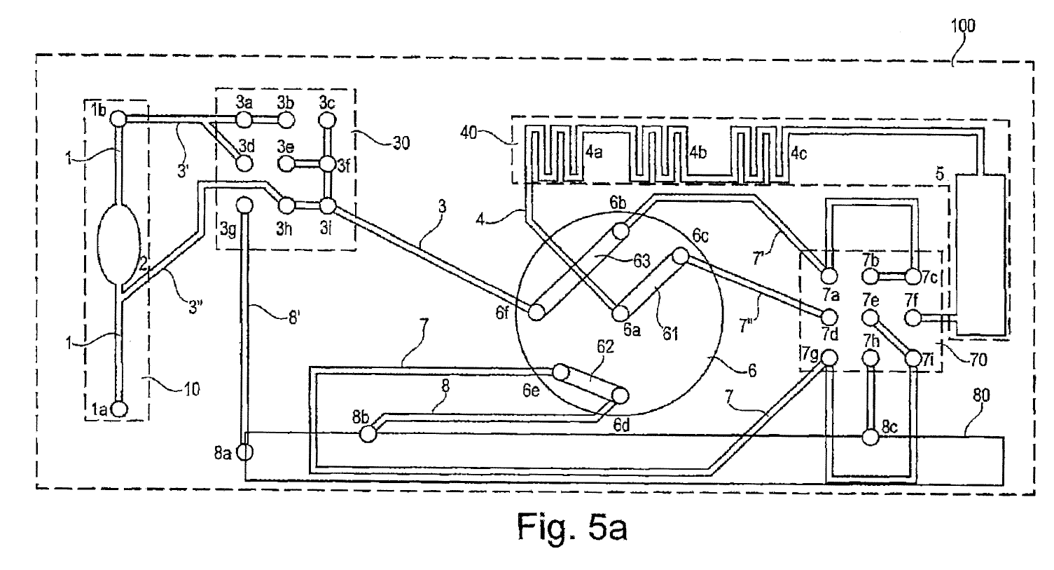

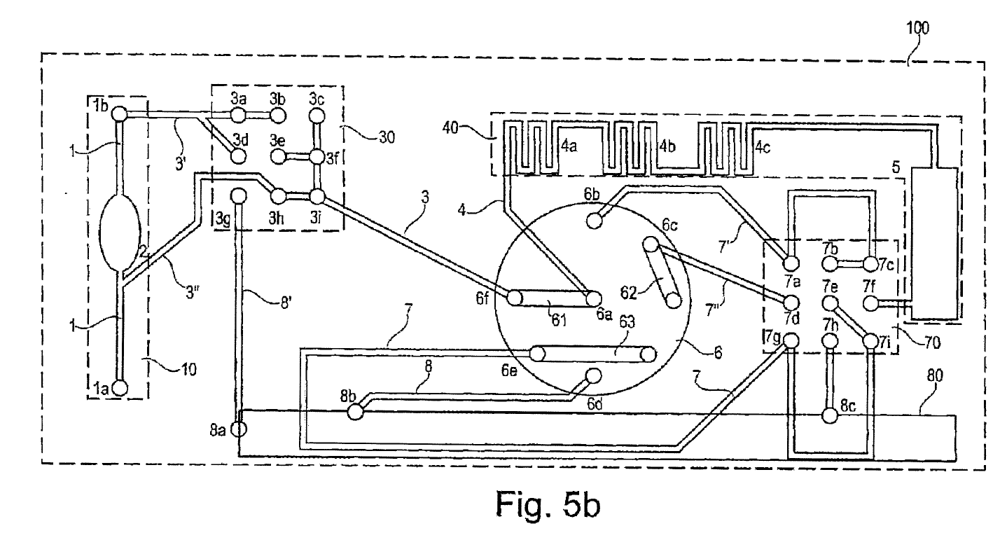

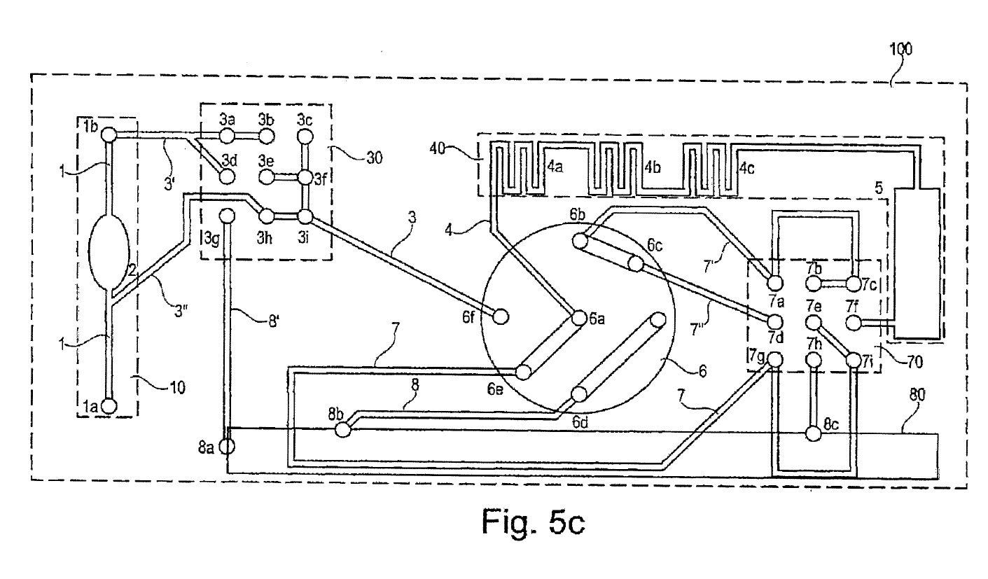

FIG. 5: schematic diagram of the microfluidics module as in FIGS. 3 and 4 with valve positions according to FIGS. 5a to 5c for an example of PCR detection;

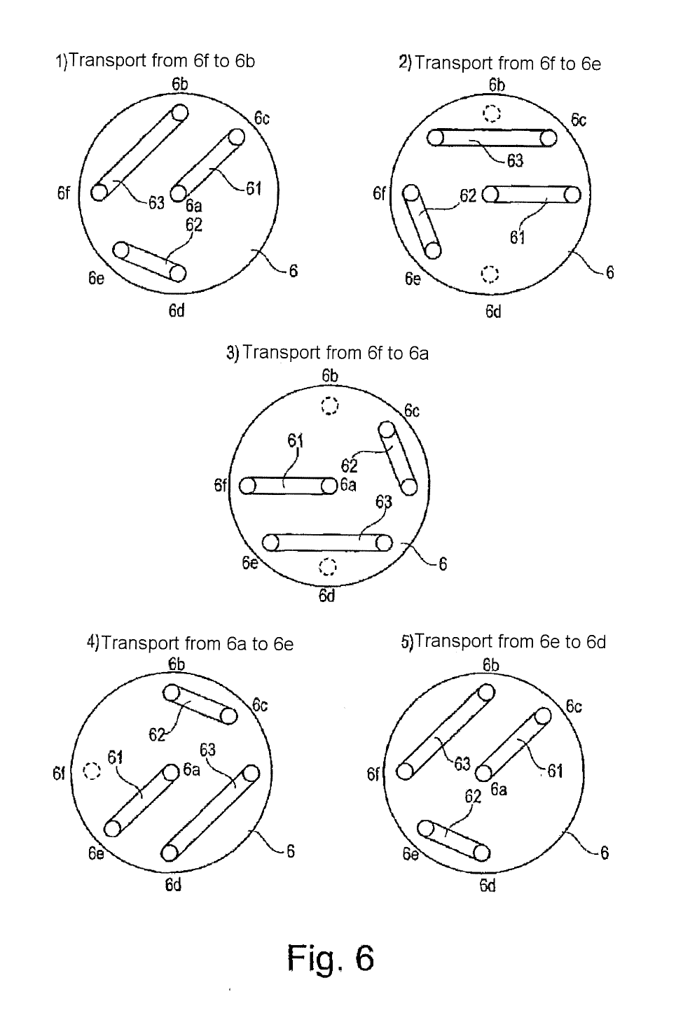

FIG. 6: detailed sketches 1) to 5) relating to the multiport valve settings utilized in the examples (sectional views through the valve body)

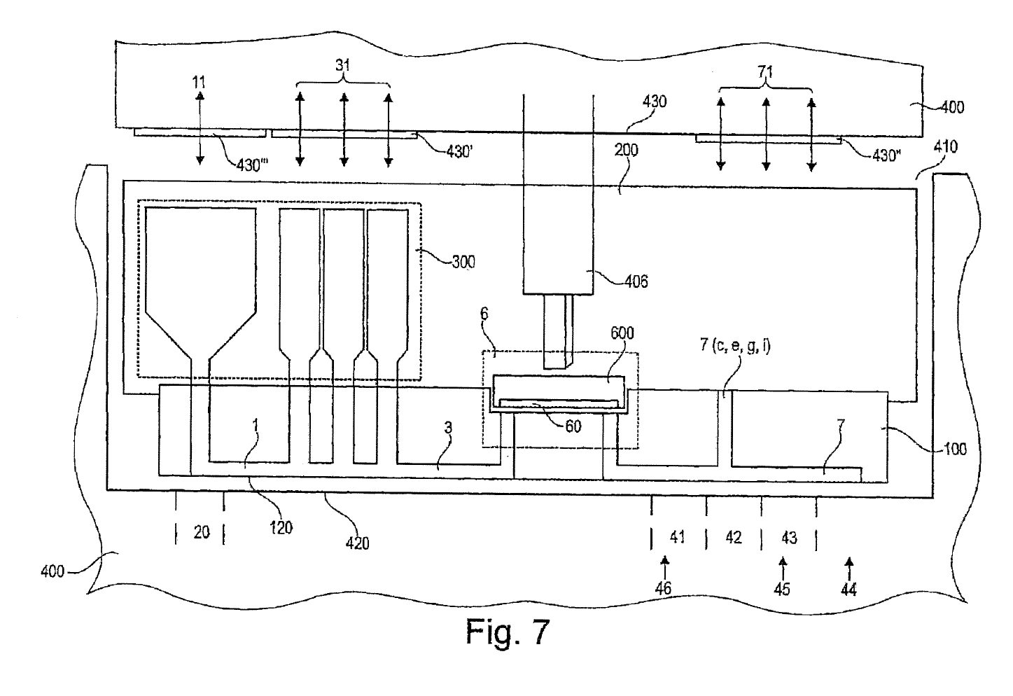

FIG. 7: schematic cross-sectional view of a section of the analyzer containing cassette and microfluidics module positioned therein;

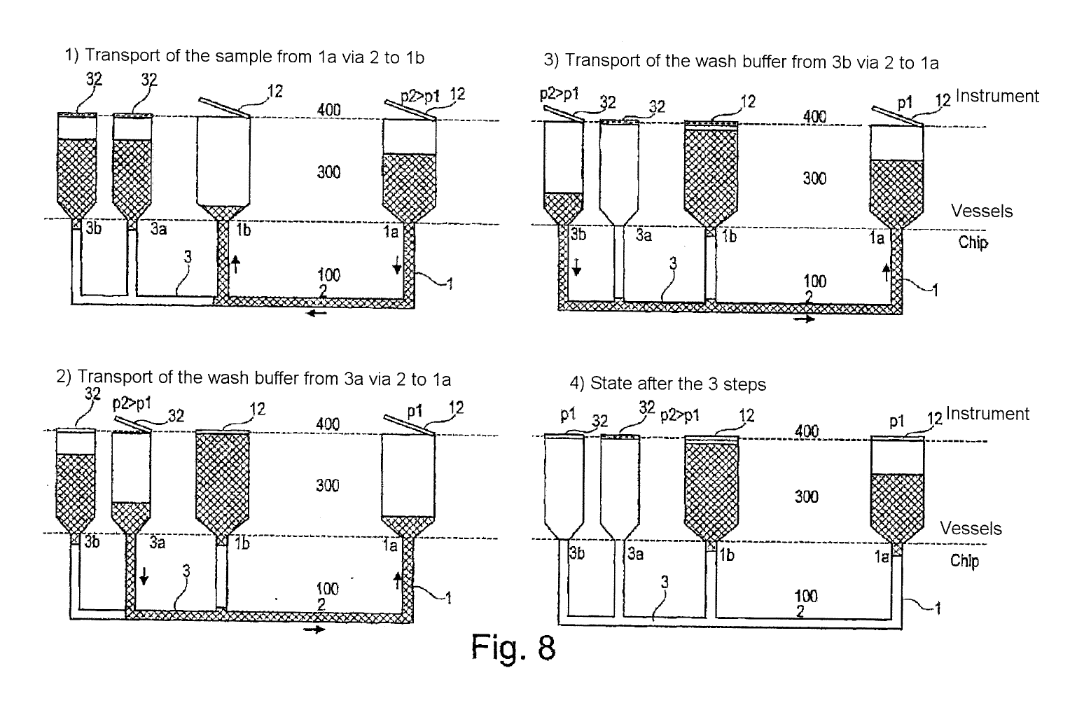

FIG. 8: schematic diagrams relating to the transport of liquid or sample from the vessels via the ports to other vessels arranged via ports—individual sketches 1) to 4), cross sections from the side.

FIG. 1 shows a flow chart depicting various assay methods which can be alternatively carried out on the new microfluidics module. For this purpose, the module is to be equipped beforehand with the associated detection means, and reagents geared to the particular assay method and also lastly the sample are to be filled into certain containers which are assigned to associated ports on the microfluidics module. The containers can be combined in blocks in a reagents module. FIG. 1 shows six assay sequences in the order of their individual steps.

Method a): is a simple immunological detection in which the presence of a certain analyte can be immediately indicated by means of a detection reagent. In the case of this assay method, it is merely necessary to move an aliquot of the sample to the detection means. In the case of this detection method, only a very small fraction of the chip setup and of the microfluidic structure on the module is utilized. Nevertheless, it is advantageous that even a simple test, such as “method a)”, can be carried out on the same module. It is very convenient for the person carrying out the assay, and it is less error-prone working with a single analyzer and equipping it for each assay with disposable articles which are similar and are known in terms of handling.

Method b): is an immunological assay in which the sample additionally passes through a purification or separation method. In this case, a zone of the microfluidics module is additionally utilized in comparison with method a), on which zone a purification or separation is carried out with the aid of reagents intended for this purpose and a certain procedural scheme within the fluidics channels of said zone.

Methods c1 and c2): are methods for the molecular detection of an analyte by means of DNA amplification. In comparison with the immunological methods, steps are added here for measuring the sample before and after the amplification and also for carrying out the method itself, which requires, inter alia, a zone on the microfluidics module, which zone is designed for exact temperature adjustment, i.e., including heating and possibly cooling. Methods c1) and c2) differ in the presence or absence of a hybridization step. Comparison of the procedures shows that additional routes or loops can be readily taken into account.

Methods d) and e): show procedures for DNA amplification methods on ribonucleic acids. In these cases too, the method is modified in comparison with DNA detection in order to be able to include a step for the treatment with reverse transcriptase.

In the prior art, the parallel or alternative processing of the assay methods shown here as basic principles was very frequently made possible by largely parallel fluidics paths. This gave rise to very complex setups of the microfluidics chips. Universal use was generally ruled out solely through the dimensioning of certain components. As shown by FIG. 2, the alternative performance of the methods shown in the flow charts is possible in the invention as a result of the methods with their treatment steps consisting of one or more substeps being processed on the module with the aid of a structure coordinated radially via a central multiport valve. Owing to the radial arrangement of zones representing the main processing steps of the methods, the module is simplified by multi-use of the channels and becomes universally usable. The assay methods are accomplished, firstly, by means of specific material transport within the fluidics channels, as already absolutely known, and, secondly, by means of the control of the multiport microvalve used as selection means and connection means.

Examples of methods a) to e) are specified below in the example section.

FIG. 2 shows a different type of flow chart, specifically the realization of the methods shown in FIG. 1 on the chip through the spatial combination of certain structures to give zones on the chip and through the selection and linking of said zones within the assay procedure via a central multiport valve. Dashed boxes indicate that material can be introduced into the microfluidics structure in said zones from the outside, i.e., from beyond the chip level. This generally occurs via ports, i.e., intakes which are sealable when necessary, via which ports it is possible to introduce samples, reagents, auxiliaries, etc. from individual, separate containers, or from containers formed on the module, or from a storage or reservoir module which is also referred to as reagents module in the context of this invention. A first zone on the left-hand side of the figure depicts sample feeding and sample (pre)treatment. The sample to be tested is always introduced above an associated port into a container. From there, the sample can be directly fed via a channel to the multiport valve and to further treatment of said sample. It is similarly possible to feed the sample to a container containing first reagents for treating said sample. In the sample container, a mixing can also be carried out. A zone for sample conditioning is envisaged, branching off from this “sample to multiport valve” first path. From further containers, it is possible to add purification reagents or first treatment reagents, and a first treatment or conditioning of the sample takes place before said sample is fed to the multiport valve for the selection of further steps. As indicated by dashed boxes, there are further ports and associated containers for the feeding of further reagents of all kinds (RT, PCR, detection). It is particularly preferred when the ports and containers are arranged in a spatially unitary zone so that the associated containers can be combined in a space-saving manner in a reagents module. However, sample(s) and reagents can also be arranged in multiple zones possibly also spatially separated from one another. The zone having the reagents ports can preferably also contain the ports for the purification and detection reagents, which are presented here at a separate place for the sake of clarity. The reagents of said zone include the reverse transcriptase solution (RT reagent), PCR reagents, such as the PCR master mix and possibly probes, wash buffer, elution buffer, running buffer, neutralization buffer, and many more. Reagents feeding too is connected to the multiport valve via channels. Said channels possibly branch out in the direction of sample conditioning and sample provision.

Microfluidic means fundamentally known as such for the performance of DNA analyses on a microfluidics chip are arranged in a further zone. Said means generally comprise channels and/or cavities which allow a specific temperature adjustment during the treatment steps. This PCR zone too is directly connected to the multiport valve and is controlled thereby when necessary by establishing connections from sample feeding to this area, on the one hand, and between the temperature-adjustment or amplification area and further areas, on the other. Measuring routes for measuring the sample before or after treatment steps are arranged in a further zone. It is particularly advantageous to have the measuring means and routes available in a closed zone, since there is a need there for valves and membrane covers which can be favorably combined in one zone. The zone for volume measurement can be divided into multiple, individually accessible subzones. At the same time, said zone is the functional area for system venting. The measurement route or measurement routes too are again directly connected to the multiport valve. Lastly, at least one channel leads from the multiport valve to the area in which detection takes place. This is preferably an elongated indentation for the detection means, which indentation is referred to here as a detection channel. Preferably, a lateral flow dipstick can be inserted into the detection channel, though other forms of detection, for example adsorption to loose column materials, are possible.

The more detailed design of the paths on the microfluidics module is depicted in FIGS. 3 to 5.

First of all, FIG. 3 will be used to elucidate first aspects of the structure of the universal microfluidics module and also the handling of immunological samples on said module. Sample feeding and a first sample conditioning are combined in a first zone 10 of the module. It would likewise be possible to separate sample preparation and sample feeding from sample conditioning into two zones, though this is not done here. Within the zone 10, there are two ports 1a and 1b, i.e., intakes to the microfluidic structure, onto which nondepicted containers are placed, which containers have a volume suitable for accommodating the sample to be tested and possibly first reagents to be directly mixed with the sample. In this example, the sample feeding always takes place to port 1a. The volume of the vessel for port 1a can be substantially larger than the volume of the channel 1 between port 1a and port 1b and the volume of the cavity 2 taken together. Therefore, the vessel for port 1b has preferably a corresponding size to the vessel above 1a, and so it is also possible to channel relatively large sample volumes from 1a via a first microfluidic channel 1 to the vessel above 1b. On the path from 1a to 1b, the sample passes a structure for slowing down the flow, which structure is provided in this example by means of a volume expansion to give a cavity 2. It is self-evidently possible to use at this place other means, such as, for example, multiple cavities placed one after another.

Ports 3a to 3i are arranged in a zone 30 which is lying next to the zone 10 or is adjacent thereto, onto which ports it is possible to place containers for the feeding of various reagents. In this example, there are nine ports, though it is readily possible to use more ports or fewer ports. The ports 3a to 3i are interconnected via a channel structure 3 having channels 3, 3′ and 3″ via the cavity 2, and connected to the sample feeding and sample conditioning region 10 having channel 1. In addition, the channel structure 3 from zone 30 is connected to the multiport valve 6 in order to be able to be linked therefrom with further structures. As a result, it is ensured that the reagents can both be mixed with the sample via channel 1 and cavity 2, and be fed to other structures via the multiport valve 6. From port 3g, a channel 8′ leads to the connector 8a on the detection channel 80 for the detection route. Where necessary, running buffer for a detection dipstick or some other detection means, for example in the form of a loose material (miniaturized column), can be fed via port 3g.

The multiport valve 6 is configured here as a rotary valve and has a cylindrical valve body in a valve seat formed in the substrate of the microfluidics chip 100. In this example, it has six inputs or outputs 6a to 6f, specifically a central intake 6a and also five intakes arranged on the circumference, which intakes can, by rotation of the valve body, be aligned with the channels leading to the valve 6. The valve body has three connection channels which make it possible to make each selection of channel linkages that is required for the assays to be carried out. The multiport valve 6 accomplishes this with three connection channels, a first connection channel 61 from the central intake 6a to a peripheral valve input, a second connection channel 62 which can link together two channels which are next to one another on the circumference and lead to the valve, and a third connection channel 63 which can link a channel leading to the multiport valve 6 with the next but one channel leading to the valve 6, in this case the intakes 6d and 6f. In the present example, the connection channels 61 and 62 are not utilized, and merely the linkage between channel 3 and channel 8 to the intake 8b on the detection channel 80 is established. All further channels coming from the zones to the multiport valve 6 come to a dead end, i.e., are not involved in the particular treatment step of the detection method.

The zones 40 and 70 will be elucidated in the course of FIG. 4.

### Examples in Relation to Immunological Assay Methods

Two examples will be specified below, showing how immunological assays can be carried out using the exemplary embodiment shown in FIGS. 3 and 4 of the universal microfluidics module.

### EXAMPLE 1

### Method a)

Immunological Detection of the Pregnancy Hormone hCG from Urine

Reference is made to FIG. 3. The microfluidics module 100 is equipped with an assay dipstick suitable for the immunological detection of the pregnancy hormone hCG. This is a lateral flow dipstick (LFD). The dipstick is inserted into the recess (the detection channel 80) by the manufacturer of the microfluidics module or possibly in a laboratory just before the assay, which recess is then covered.

The microfluidics module 100 is designed such that containers for sample solutions and reagents can be put on the intakes to the individual microfluidic flow lines or channels 1 and 3 to 8, at so-called ports 1a, 1b and 3a to 3i. Many analyzers are designed to accommodate a cassette which contains the microfluidics module 100 or is combined therewith. The cassette can be configured such that it stabilizes the individual fluid containers. It is also possible for the containers to be combined in a so-called reagents module in order to simplify handling. This is explained in more detail below.

In the present case, only a single container for the urine sample is needed, which container must be placed onto the port 1a. To this end, either an individual container can be placed onto port 1a or the stated cassette, which is not depicted here, can be put together with the microfluidics module, whereupon the urine sample to be tested is filled into the vessel for port 1a and the vessel is then closed. The thus completed cassette is inserted into the associated analyzer. Thereafter, the procedural control which matches the analysis and which carries out the following steps is started: the liquid from the container for port 1a is moved through channel 1 and the channels 3″ und 3 below the ports 3h and 3i to the valve connection 6f, then through the connection channel 63, from valve connection 6d via channel 8 to the detection channel input 8b, and is thus fed to the detection means, i.e., to the LFD in this case. The movement of the liquid, specifically the urine sample, can be achieved pneumatically for example. The ports 1b and 3a to 3i are closed during the transport of liquid; venting is done via port 7h (see below). In this example, pressurized air is first applied to the container above port 1a, which pressurized air transports the sample through the stated channels to the detection area 80. The ports 1b, 3a, 3b and 3d are blocked with sealers or closed valves in order to prevent the sample containing the analyte from flowing at the branching point of the channel from channel 1 into a cavity 2 present therein for other purposes and onward in the direction of the ports 1b and 3a, 3b and 3d. The air situated in the cavity 2 and the channels 1 and 3 therebehind then prevents the sample liquid from entering this area. The air situated in the flow direction ahead of the urine sample escapes via venting of the detection channel 80 via the connector 8c and the opening 7h which is connected thereto and closed by a gas-permeable membrane. Once the sample is situated in the detection channel 80 and wets the lateral flow dipstick, said dipstick starts to develop by itself and indicates the assay result after a certain time. The readout is done optically through a window or using an optical or spectroscopic unit on the analyzer. These methods are absolutely known and will not be explained in detail here.

As is evident, only a very small part of the structure of the microfluidics module 100 is used in this example, whereas further areas have been shut down owing to the position of the multiport valve 6, are not involved owing to their position, or are kept clear by pressurized air. The program running on the analyzer is simple too: connection of the valve inflows 6f and 6d by means of connection channel 63, closure of the ports 1b, 3a to 3i, opening of the opening 7h that was closed with permeability to gas, application of positive pressure to port 1a, waiting for development of the LFD.

### EXAMPLE 2

### Method b)

Immunological Detection from Blood with Purification of the Sample

Reference is made to FIG. 4a. FIG. 4 (4a, 4b) shows the same exemplary embodiment for a microfluidics module 100 as FIG. 3, just with other positions of the valve 6, which are different in FIGS. 4a and 4b. As described in relation to example 1, the microfluidics module 100 is first provided with a lateral flow dipstick suitable for the assay method, the cassette is put together and the vessels above the following ports are filled as follows:

Vessel for port 1a—with paramagnetic beads having a surface which has been coated with CaptAvidin and contains a biotin-coupled antibody against the target antigen to be detected

Vessel for port 3a—wash buffer

Vessel for port 3d—elution buffer

Vessel for port 3i—neutralization buffer

Vessel for port 3g—running buffer suitable for immunological identification on the LFD

After the cassette has been joined together as specified or the individual vessels have been put on the ports, the blood sample to be tested is added to the vessel 1a, which is closed. The cassette is inserted into the analyzer and the procedural control matching the analysis according to this example is started. The following steps are carried out:

Air is pumped from below into the vessel for port 1a in order to ensure, by means of movement, the mixing of the paramagnetic beads in the analyte solution. In the course of this, the antibody reacts with the target antigen from the blood and the antibody-coupled biotin with the CaptAvidin on the paramagnetic beads. Thereafter, the liquid from the vessel for port 1a is moved to an empty vessel for port 1b. This can occur pneumatically as described above. On the way thereto, the sample liquid is guided through the cavity 2, which, owing to its cross-sectional expansion, is a structure for slowing down the flow. Situated below the cavity 2 is a magnet in the cassette holder of the control instrument. It can be a permanent magnet which is movable toward the cavity 2 and away from the cavity in a specific manner by means of the analysis program, a permanent magnet permanently situated therein, or a switchable electromagnet. The force of attraction of the magnet on the paramagnetic beads must be large enough in order to tightly hold in the cavity the beads to which the antigen to be detected has bound, whereas the remaining liquid of the sample is moved into the vessel for port 1b. Instead of the cavity 2 depicted in this figure, a different structure, for example a meandering channel structure or the like, can be present. What is important is that the magnet-bound antigens are held tightly therein, whereas the liquid sample can otherwise flow further unimpeded in the direction of 1b. Thereafter, the wash buffer from the vessel for port 3a is moved through the channels 3′ and 1 and the cavity 2 in the direction of the vessel for port 1a. In the course of this, the beads are held tightly in cavity 2 by means of the magnet and “washed”. Substances which may interfere with the following reactions, but have not been bound to the beads, are dissolved by contrast and thus moved further into vessel 1a. After this has taken place, the elution buffer from the vessel for port 3d is moved into the vessel for port 3i containing the neutralization buffer. During its transport through the cavity 2, the elution buffer undoes the bond between the CaptAvidin on the beads and the biotin. The thus released biotinylated antibodies are dissolved in the elution buffer and transported together therewith into the vessel for 3i. There, the neutralization buffer neutralizes the pH of the solution. The liquid subsequently present in the vessel for port 3i is moved via the valve connection 6f and the connection channel to valve connector 6e and, from there, via the channel 7 below the detection region 80 and not connected to said detection region to the opening 7e closed with a gas-permeable membrane. During this operation, the openings 7g and 7i likewise closed with permeability to gas are sealed in a gas-tight manner on the instrument side. The sample liquid cannot escape through the membranes. Thereafter, the multifunctional valve establishes a connection from connector 6e to connector 6d, as shown in FIG. 4b, and so, as a result of a positive pressure on the connector 7i (or 7g), a defined volume of the liquid situated in the channel between 6e and 7i (or 7g) can be moved via the opening 8b onto the lateral flow dipstick. The structure 70 on the microfluidics module 100 forms a structure having measurement routes which can be utilized for measuring sample volumes in various stages of an assay. The assay steps referred to in FIG. 1 as “Measurement” are carried out by means of the structure 70 having the channels 7, 7′, 7″ and the valves or sealing units 7a to 7i. The openings 7a to 7i are in each case closed with permeability to gas, and gas-tightly sealable in a controlled manner by means of the analyzer according to the particular requirements. Therefore, they are sealing units or valves. When the measured volume of the sample liquid containing the biotinylated antibody has completely arrived at the lateral flow dipstick in the detection channel 80, the running buffer from the vessel for port 3g is moved onto opening 8a of the lateral flow dipstick area 80. The LFD starts to develop and indicates the assay result after a certain time.

### EXAMPLE 3

### Method c1)

Molecular Detection of Legionella DNA from a Water Filter by Means of PCR.

Reference is made to FIG. 5. This again depicts the same exemplary embodiment of a microfluidics module according to the invention; FIGS. 5a to 5c show various settings of the multiport valve 6.

Prior to the assay, the microfluidics module 100 has been provided with a lateral flow dipstick suitable for molecular diagnostics. The vessels to be inserted into the cassette, which vessels can be situated in a reagents module, are filled as follows:

Vessel for 1a—paramagnetic beads having a surface composed of silica and also a lysis buffer;

Vessel for 1b—matching binding buffer;

Vessel for 3h—matching elution buffer;

Vessel for 3a—wash buffer;

Vessel for 3d—wash buffer;

Vessel for 3i—PCR master mix consisting of two oligonucleotides, which, from their sequence, are suitable as a primer pair for a specific Legionella PCR, one of the oligonucleotides being labelled and the other not, additionally polymerase and other substances required for the PCR, such as magnesium chloride for example;

Vessel for 3f—probe oligonucleotide having a second label, the sequence of which binds to the Legionella DNA segment amplified by the primer pair such that a double-labeled DNA complex can form. In this connection, the labels of the one primer and of the probe are designed such that one label is tightly held by the capture substance on the beads of the lateral flow dipstick and the other label by the capture substance immobilized on the membrane of the lateral flow dipstick;

Vessel for 3g—a running buffer for the lateral flow dipstick, which buffer is suitable for molecular identification.

To carry out the analysis, the cassette is, as described in the previous examples, put together by the user. The water filter to be tested is inserted into the vessel for port 1a and the vessel is closed. The completed cassette is inserted into the analyzer and the procedural control matching this analysis is started. The following steps are carried out:

Reference is now made to FIG. 5a. Air is pumped from below into the vessel for port 1a in order to improve, by means of movement, the detachment of the bacteria cells from the water filter and the mixing of the paramagnetic beads in the solution. In parallel, the solution in the vessel for port 1a is heated by a heater suitably arranged in the analyzer for a defined period to the extent that the DNA is released from the cells under the conditions of the lysis buffer. In the next step, the binding buffer is moved from the vessel for port 1b into the vessel for port 1a. Under the conditions of the binding buffer, the Legionella DNA binds to the silica surface of the paramagnetic beads. Thereafter, the liquid from vessel 1a is moved into the vessel 1b. On the way thereto, the liquid passes the cavity 2, below which there is—as already described above—a magnet. Again, the particles coupled to the paramagnetic beads are held tightly in the structure of the cavity 2, whereas the remaining liquid is moved in the vessel for 1b. Thereafter, the wash buffer from the vessel for 3a is moved through the cavity 2 and thus across the beads in the direction of the vessel for port 1a. In the course of this, the beads are held tightly in the cavity 2 by means of the magnet. Substances which may interfere with the following reactions and have not been bound to the beads are dissolved and thus transported further and transferred into vessel for 1a. This operation is repeated with the wash buffer from the vessel for 3d. Thereafter, the elution buffer from the vessel for port 3h is moved into the structure having the cavity 2. Under the influence of said buffer, the DNA comes off the beads. Thereafter, the solution, which now contains the released DNA but no beads, is moved in the direction of the connector 7b, with the multiport valve 6 establishing a connection between the connectors 6f and 6b via the connection channel 63. The air ahead of the liquid drop escapes through the gas-permeable membrane on the opening 7b until the plug touches this liquid-impermeable membrane. In this connection, the sample liquid flows under the openings 7a and 7c, which are closed with permeability to gas, but are sealed in a gas-tight manner on the instrument side.

A program-controlled rotation of the multiport valve 6 is then carried out in such a way that a connection between the connectors 6f and 6e is established, a valve position as shown in the preceding example of an immunological assay in FIG. 4a. With the aid of positive pressure on the connectors 7e, 7g and 7i, it is then possible to flush the remaining proportion of the liquid from the channel 3 between 6f, 3i and 3h through the cavity 2 and channel 1 into the vessel for 1b. In the following step, the multiport valve 6 establishes again in a program-controlled manner a connection between the connectors 6f and 6b through connection channel 63, as shown in FIG. 5a. By means of positive pressure on the connector 7c (or 7a), it is then possible to move a defined volume of the liquid situated in channel 7′ between 6b and 7c (or 7a) into the vessel for 3i containing the PCR master mix. This produces the PCR preparation, which contains the Legionella DNA to be detected, the polymerase, the two primers and the remaining reagents required for a PCR.

The polymerase chain reaction is realized within the structure or the zone 40. Zone 40 contains a meandering channel structure composed of the subsegments 4a, 4b and 4c and also additionally here a cavity 5 for further functions, for example collection or equalization. By means of underlying heaters in the analyzer, these zones are heated to the temperatures required for the particular work step, specifically segment 4a to the melting temperature of the primers, segment 4b to 72° C. and segment 4c to 95° C. The PCR preparation is transported from vessel 3i via channel 3 to the connection 6f of the multiport valve 6 and, from there, via connection channel 61 to the valve intake 6a, as shown in FIG. 5b. From there, the PCR preparation enters the meandering structure having the subareas 4a, 4b and 4c until the liquid triggers a light barrier which is arranged after 4c and which is not depicted in the drawing.

Denaturation is then carried out in the PCR preparation. Thereafter, the liquid to be tested is moved into the substructure 4a, where annealing of the primers to the DNA to be detected takes place. Thereafter, the liquid to be tested is moved into detailed structure 4b, where the polymerase completes the primers on the basis of the Legionella DNA present to give a double strand, if the assay proceeds positively (elongation). The sequence of the substeps (denaturation, annealing and elongation) corresponds to a PCR cycle and is repeated until the program-defined number of PCR cycles has been reached. After completion of the last elongation, the liquid, which now contains many labeled amplicons, is moved via the multiport valve 6 via connection channel 61 from 6a to 6f in the direction of 3f and collected in the overlying vessel, where the sample liquid then picks up the oligonucleotide probes. Thereafter, the solution is moved back again into the meandering structure until the liquid is positioned in the substructure 4c. Here, the labeled amplicons are denatured. A transport onto the substructure 4a adjusts the temperature of the solution such that the labeled probes hybridize to the labeled amplicons. The liquid containing the thus double-labeled amplicons of the Legionella DNA is, following program-controlled rotation of the multiport valve 6 as now shown in FIG. 5c, moved through the connection channel 61 from 6a to 6e into the channel 7 up to the opening 7e closed with a gas-permeable membrane. The liquid cannot escape through said membrane. Thereafter, the multiport valve 6 is adjusted in a program-controlled manner such that a connection from 6e to 6d via connection channel 62 is established again, as shown in FIG. 5a. By means of a positive pressure on the connector 7i (or 7g), a defined volume of the liquid situated inside the channel 7 between 6e and 7i (or 7g) is moved via channel 8 and the opening 8b onto the lateral flow dipstick. When this volume of the liquid, which contains the double-labeled DNA complexes, is completely on the lateral flow dipstick, the running buffer from the vessel for port 3g is moved through channel 8′ and via opening 8a of the detection region 80 onto the lateral flow dipstick. This subsequently starts to develop and indicates the assay result after a certain time.

### EXAMPLE 4

### Method c2)

Molecular Detection of Legionella DNA from a Water Filter by Means of Hybridization During the PCR.

In this example, the probes described in example 3 are directly present in the PCR master mix. In this case, a final heating step following the polymerase chain reaction carried out to completion in region 40 is sufficient for allowing the hybridization to proceed. Therefore, the separate pickup of the hybridization mix can be omitted. Apart from that, the assay procedure is as described in example 3 with reference to FIG. 5.

### EXAMPLE 5

### Method d)

Serotype Differentiation of Dengue Viruses by Means of Two-Step RT-PCR.

Since dengue viruses are part of the RNA viruses, RNA must first be transcribed into DNA before said DNA can be identified as above with the aid of a polymerase chain reaction. The transcription is usually done using an enzyme referred to as “reverse transcriptase” (RT). In comparison with the DNA identification described in the preceding example (see FIG. 5), the following changes are required:

The microfluidics module 100 is provided, by the manufacturer, with a lateral flow dipstick suitable for the molecular detection of four target molecules. The vessel for 3c contains an RT master mix consisting of the RT enzyme, the appropriate buffer reagents and also the oligonucleotides required for the reverse transcriptase. The vessel for port 3i contains a PCR master mix which, firstly, consists of four oligonucleotide pairs which, from their sequence, are suitable for a specific PCR of each of the four dengue serotypes, one oligo of the pairs being labeled and the other not. In addition to the eight oligonucleotides, the PCR master mix further contains the polymerase required for the PCR, and other substances such as, for example, magnesium chloride. The vessel for port 3f contains four probe oligonucleotides having in each case a second label, the sequence of which binds to the dengue DNA segments amplified by primer pairs such that double-labeled DNA complexes can form. In this connection, the labels of the particular one primer and of the particular probes are designed such that one label is tightly held by the capture substance on the identification beads of the LF dipstick and the other labels by, in each case, one of the capture substances immobilized on the membrane of the LF dipstick.

The procedure differs from example 3 only in that the RT step is inserted. To this end, the first measured quantity of liquid is conducted into the vessel for port 3c and not into that for 3i before the resultant mix is incubated in substructure 4a, which is appropriately adjusted in temperature as in the other examples. After a defined time, said mix is conducted into the vessel for port 3i, where it mixes with the

PCR master mix. From this step, the rest of the procedure follows the sequence as in example 3. In comparison with example 3, the LF dipstick used in this example can display a line for each serotype.

### EXAMPLE 6

### Method e)

Dengue Viruses with Serotypes, Detected by Means of One-Step RT-PCR.

This RNA detection utilizes enzymes which have both RT and PCR activity. In comparison with the RNA identification described in example 5 having separate RT and PCR steps (“two-step”), the following changes are required:

The vessel for port 3i contains an RT-PCR master mix consisting of the enzyme, the appropriate buffer reagents and also the above-described oligonucleotides. The procedure corresponds to the procedure of the RNA identification described in example 5 having separate RT and PCR steps (“two-step”), with the first measured quantity of liquid being conducted into the vessel for port 3i before the RT incubation takes place. In addition, the steps for incorporating the PCR enzyme are omitted. The procedure corresponds to the procedure for DNA detection, supplemented by an additional incubation step before the PCR.

FIG. 6 shows the valve positions of the multiport valve 6, as utilized in the examples, in a sectional view through the valve body in the plane of the channels in order to illustrate again that the various necessary paths on the microfluidics chip 100, as described above, can be realized with the aid of a single valve, which is rotatable in the example. FIGS. 6.1) to 6.5) show the multiport valve 6 in various positions of the rotating body in a fixed valve seat having the channel intake points 6a to 6f, which are behind the section plane and are depicted here in dashed form for the purpose of orientation. Six channels of the microfluidic structure enter into the valve seat, which is not depicted here, five of the channels leading to the peripheral intake points 6b to 6f and one channel leading to the central intake point 6a. However, the peripheral intake points are not evenly distributed over the circumference of the valve seat, offering the possibility of sealing certain channels, whereas others are bridged and thereby connected to one another with the aid of the connection channels 61, 62 and 63 on the valve. The connection channels 61, 62 and 63 are designed such that the channel leading to the central input 6a can be connected as desired to one of the channels entering at the periphery, specifically depending on the valve position with each of these channels. Connection channel 62 allows the connection of two adjacent channels entering at the periphery and connection channel 63 allows the connection of a channel entering at the periphery to the next but one channel entering at the periphery. As a result, the arrangement of the connection channels is selected such that very specific connection patterns can be realized. This makes it possible to carry out a very wide variety of different assay configurations.

It is self-evidently possible to design the valve differently. Instead of the rotary valve, a slide valve can also be envisaged, though this requires a different distribution of the zones 10, 30, 40 and 70 relative to the detection area 80.

FIG. 7 illustrates very schematically the position of a cassette 200 containing a microfluidics module 100 within an analyzer 400 having a recess 410 intended for the cassette 200. The recess 410 is usually designed such that the cassette 200 can be inserted with an exact fit. The microfluidics module 100 has a level base plate 120, by means of which it rests on a (cassette) holder 420 of the instrument 400 that is formed in a mirror image. This makes it possible, via the contact surface of the holder 420, to exert an effect in a specific manner on the channel structure close to the base in the microfluidics module 100, as will be described below. The cassette holder within the instrument 400 comprises here the sealing blocks 430 having the substructures 430′, 430″ and 430′″, which press and fix the cassette from “above”, i.e., from the containers and reagents module side, against the holder 420. The sealing block 430 consists of sealing subunits, specifically the sealing blocks 430′ and 430′″, which seal the openings on the upper side of the vessels which are assigned to the ports of the microfluidics module and which are situated here within a reagents module 300, and the second sealing block 430″ above the openings 7a to 7i closed by the membranes. Besides means for holding the cassette 200 including the microfluidics module 100, the analyzer 400 comprises an actuator and a control element 406 for the multiport valve 6, at least one pump for gas and/or liquids, heaters, optionally one or more light barriers, pressure and temperature sensors, a magnet and means for procedural control. The area 20 for the arrangement of the magnet below the cavity 2 of the microfluidics module 100 is indicated by dashed lines. Furthermore, the areas 41, 42 and 43 in which the heaters for the temperature adjustment of the PCR area are situated are indicated by dashed lines. Light barriers present in this example are indicated here by the arrows 44 to 46, for example 44 at the end of the zone 4c of the PCR channel system. For the handling of the universal microfluidics module 100 elucidated in more detail in the examples and of the associated cassette 200, the holder additionally comprises at least one pressurized air feed 11 for applying pressure to components and, for example, mixing the liquid in sample vessel for port 1a with air. Further means for handling from the holder side 420 are just as possible as from the side of the sealing block 430. By means of two pumps, which can generate here both positive and negative pressure, and multiple switch valves, it is possible in combination with the sealing blocks 430′, 430″ and 430′″ to ensure that all openings of the cassette 200 or of the reagents module 300 can be individually provided with different pressures in each case. Said pressures are measured and monitored by the pressure sensors. The rotating body 600 of the multiport valve 6 is moved by the actuator with control element 406 and what is controlled is which valve openings are connected via the connection channels 61, 62, 63, denoted here summarily by 60. Additional light barriers 45, 46 indicate when liquid is situated in their focus and thus make it possible to position the liquid within the PCR zone 40 above the temperature-adjustment regions 41 to 43. Otherwise in a conventional manner, the procedural control implements individual steps of a program in terms of actions of certain instrument elements. Setting of a temperature for a heater within the regions 41 to 43 leads, for example, to the flow through said heater being regulated according to the measurement value of the temperature sensor (not depicted here), and so the desired temperature remains constant. Further program steps are the setting of a state of a switch valve, the rotation of the multiport valve 6 to a defined position, the positioning of a liquid within the cassette 200, etc. By combining these steps, it is possible to realize complex procedures. The procedural control can link certain program steps with customary conditions, such as “if—then” or “for so long—until”. This makes it possible to reproduce the work steps under defined conditions. The sample can then pass through all steps within the cassette that are required for a diagnostic analysis. As described above, the sealing blocks 430′, 430′″ are used to establish seals for the openings of the vessels for the individual ports in the microfluidics module 100. Pressurized air is provided in a specific manner through said sealing blocks 430′, 430′″ in order to convey the liquids situated in the vessels into the channel system of the microfluidics module 100 by means of pressurized air. The possible feeding of pressurized air is depicted by the arrows at positions 11 and 31. The procedure in this regard will be further elucidated in more detail with reference to FIG. 8. Furthermore, in the case of the exemplary embodiment already described above, pressurized air is required for application to the openings 7a to 7i which are sealable on the instrument side by the valves and provided with gas-permeable membranes. This pressurized air feed is illustrated by the arrows at position 71. In the example shown here, the vessels for the individual ports of the microfluidics module 100 are combined in a reagents module 300. In this case, it can be a unitary component which is, for example, an injection-molded part in which the vessels or containers for the accommodation of sample and reagents are formed. The reagents module 300 is handled in one piece and put on the microfluidics module 100. It can be connected as one piece to the cassette 200 shown here.

FIG. 8 shows in detail the transport of liquids, specifically the sample and the reagents, from the vessels for the ports into the microfluidics channels. FIG. 8.1) shows the transport of a sample from the vessel for port 1a via the cavity 2 into a vessel having a corresponding volume for port 1b. For the purpose of illustration, liquid-filled vessels for the ports 3a and 3b are additionally shown, the closures 32 of which are closed. By sealing these reagent vessels, a downward flow of the reagent liquid through the ports 3a and 3b is prevented. For the transport of the sample from 1a to 1b, closures 12 of the associated vessels are opened and a pressure difference is set between said closures 12. In this case, the higher pressure is fed to the filled sample vessel for port 1a and the liquid is thereby pushed in the direction of the lower pressure through channel 1 and cavity 2 to port 1b into the overlying vessel, which is initially empty. This movement proceeds as long as the pressure difference is maintained. The transport is continued until the complete transfer of the sample into the vessel for 1b.

FIG. 8.2) shows the transport of a wash buffer from the vessel for port 3a through channel 3 and cavity 2 into the vessel for port 1a. As already depicted in FIG. 8.1, vessels having closed closures and 12 are not involved. For the transport to be carried out here, the vessel for port 3a, which contains the wash buffer, is opened. A pressure p2 is fed via the closure 32, which pressure is greater than the pressure p1 on the opened sample vessel for port 1a. The liquid situated in the vessel for port 3a, specifically the wash buffer, is thereby moved through channel 3 and cavity 2 into the previously empty vessel for port 1a. FIGS. 8.3) and 8.4) show corresponding operations for the transport of the wash buffer from 3b via 2 to 1a and the state of the system depicted here by way of example after termination of the three above-described steps.

Transport within the measurement routes 7, 7′, 7″ is carried out in a similar manner. A measurement route is filled by, firstly, the multiport valve 6 establishing a connection between the valve attachment point (6b or 6e) belonging to the measurement route and that valve attachment point which is connected to the channel in which the liquid is currently situated. Secondly, the connector at the end of the measurement route (7b, 7d or 7e), which connector is closed with a gas-permeable membrane, must be opened on the instrument side. And thirdly, pressurized air must be applied to a port which, from the perspective of the measurement route, is situated on the other side of the liquid. As a result, the liquid is driven from its position through multiport valve and the channel structure 7, 7′, 7″ in zone 70 until the liquid hits the gas-permeable, liquid-impermeable membrane at the end of the measurement route (7b, 7d or 7e). By opening a port on the other side of the measurement route and feeding pressurized air onto one of the membranes of the measurement route (7b, 7c, 7d or 7a, or 7e, 7i or 7g), it is similarly possible to drive back again a defined volume of the liquid, i.e., the measured liquid volume can be transported further to another work step.

1. A microfluidics module configured both for the immunological and molecular diagnostics of samples, in which channels and/or cavities having inlets for fluid samples and reagents, are configured in a base body, wherein containers, container accommodators or container attachment points are assigned to the inlets, and a detection channel for accommodating an assay-specific detection means connected or connectable to channels of the module, comprising:
exactly one multiport valve which connects individual channels;
channel structures including i) at least channels and/or cavities for sample guidance which include conditioning necessary for certain assays, ii) channels for reagent feeding, iii) a channel structure with channels for a temperature adjustment and/or a DNA amplification and iv) a channel structure for a defined volume measurement of a fluid moved through certain channel segments, wherein the channel structures are all directly or indirectly connected to the one multiport valve, with at least segments of the channel structures and channels forming, according to their function or to treatments to be performed therein, coherently arranged zones; and
a connection of the detection channel at least to volume measurement and to sample and reagent feeding via the multiport valve.

2. The microfluidics module as claimed in claim 1, further comprising a base surface configured on the base body for contact with an associated analyzer and wherein at least some of the channels and/or cavities are, at least in segments, configured such that they lie close to the base surface in order to allow a manipulation or identification by elements of the analyzer related to procedures controlled by the analyzer.

3. The microfluidics module as claimed in claim 1 wherein the multiport valve is configured as a rotary valve or as a slide valve.

4. The microfluidics module as claimed in claim 1 wherein the multiport valve has valve positions by means of which at least the following zones can be connected to their associated channel structures and channels:
i) the zone for sample guidance to the detection channel;
ii) the zone for sample guidance to the zone for volume measurement;
iii) the zone for sample guidance to the zone for temperature adjustment;
iv) the zone for temperature adjustment to the zone for volume measurement; and
v) the zone for volume measurement to the detection channel.

5. The microfluidics module as claimed in claim 1 wherein the multiport valve has settings for connecting the zones to one another in various possible combinations.

6. The microfluidics module as claimed in claim 1 further comprising one or more connect means for one or more of
for transporting a fluid through channels of the module,
for applying negative or positive pressure,
for feeding pressurized air into individual channels, and
for purging gases from individual channels in a liquid-tight manner.

7. The microfluidics module as claimed in claim 1 wherein the module substantially consists of a plastic and is formed in one piece or in multiple pieces.

8. The microfluidics module as claimed in claim 1 wherein the base body has formed open cavities and channels and the module includes a cover for closing said open cavities and channels.

9. A cassette for the accommodation of a microfluidics module as claimed in claim 1, which cassette is configured for a form-fitting and/or force-fitting insertion into a holder of an associated analyzer.

10. The cassette as claimed in claim 9, wherein the cassette is configured to function as an interface between the microfluidics module and the analyzer and allows performance of assays on the microfluidics module, which performance is program-controlled by means of the analyzer.

11. An analysis unit containing a microfluidics module as claimed in claim 1 optionally equipped with an assay-specific detection means.

12. The analysis unit as claimed in claim 11, further comprising one or more containers formed in one piece or in multiple pieces and arranged so as to be assigned to the inlets of the microfluidics module and which provide volumes for reagents and samples.

13. The analysis unit as claimed in claim 12, wherein the one or more containers are formed within a coherent reagents module, said reagents module being integrated with the microfluidics module on a side facing away from a base surface of the microfluidics module or being connectable thereto in such a way that said one or more containers of the reagents module containing volumes for reagents and samples sit on container attachment points of the microfluidics module in order to be able to feed samples and/or reagents to the channels and/or cavities via the inlets.

14. A reagents module containing containers formed therein, and being configured for feeding reagents and samples which are introduced in the containers formed in the reagents module to the channels and/or cavities of a correspondingly configured microfluidics module as claimed in claim 1 via container attachment points of the microfluidics module.

15. A method for carrying out both immunological and molecular assays using the microfluidics module as claimed in claim 1 within an analyzer, comprising:
introducing a detection means in the microfluidics module;
introducing at least one sample and optionally one or more reagents in an analysis unit comprising the microfluidics module or a cassette accommodating the microfluidics module configured for a form-fitting and/or force-fitting insertion into a holder of the analyzer or in the microfluidics module itself and feeding the sample and the one or more reagents to the channel system of the microfluidics module in an instrument-controlled manner and involving conducting the sample and optionally the one or more reagents in a controlled manner by means of the analyzer through microfluidic channels; and
feeding the sample and the one or more reagents to a detection means after carrying out a selection of the instrument-controlled operations selected from the group consisting of: transportation, washing, purification, selection of labeled molecules, mixing, mixing with reagents, allowing to react, adjustment of temperature, heating, cooling and measuring,
wherein an assay-specific program sequence is installed on the analyzer and is composed of steps which proceed in the zones of the microfluidics module and which steps are selected via the one multiport valve into which channels of the zones open and are linked in a sequence of method steps.

16. The method as claimed in claim 15, wherein after the at least one sample, which has optionally been mixed with reagents depending on the assay method selected or which has optionally been subjected to a purification, concentration and/or selection method, has been fed through a microfluidic channel to the multiport valve, a selection controlled by the selected analysis program matching the assay method is made, according to which selection the multiport valve through connection of certain channels selects in analysis steps from the following method steps and carries them out in an appropriate order:
transport of a sample volume, measurement of a sample volume, purification of a sample, selection of labeled molecules, washing and/or concentration of an analyte, amplification of DNA, hybridization of DNA to probes, transcription of RNA into DNA by means of reverse transcriptase, before the treated sample, likewise mediated via the multiport valve, is fed to the detection step within the detection channel.

17. The analysis unit of claim 11 which includes the assay specific detection means and wherein the assay specific detection means is a lateral flow dipstick.

18. The microfluidics module as claimed in claim 5, wherein the zones include the detection channel.
